(19) United States
(12) Patent Application Publication
(10) Pub. No.: US 2019/0079875 A1
(43) Pub. Date: Mar. 14, 2019

(54) EFFICIENT PROVISIONING OF VIRTUAL MACHINES TO ENDPOINT COMPUTING ENVIRONMENT

(71) Applicant: Citrix Systems, Inc., Fort Lauderdale, FL (US)

(72) Inventor: Simon P. Graham, Burlington, MA (US)

(21) Appl. No.: 15/704,911

(22) Filed: Sep. 14, 2017

(51) Int. Cl. G06F 12/1018; G06F 9/50

(52) U.S. Cl. CPC G06F 12/1018; G06F 9/45558; G06F 9/5077

(57) ABSTRACT

Provisioning a virtual disk at an endpoint client, involves calculating local hash values for local blocks comprising a local operating system boot disk and creating a local hash table (LHT) containing at least the plurality of local hash values. A provisioning server communicates to the endpoint client a plurality of image hash values for image blocks comprising an image boot disk. The image hash values are compared to the local hash values contained in the LHT to identify one or more matching hash values in the LHT which are identical to one or more of the plurality of image hash values. Thereafter, one or more of the local blocks corresponding to the matching hash values are copied to the virtual disk.

### BACKGROUND

### Statement of the Technical Field

The present disclosure relates generally to cloud computing systems. More particularly, the present invention relates to implementing systems and methods for provisioning virtual machines in endpoint computing equipment.

### DESCRIPTION OF THE RELATED ART

Desktop virtualization is a type of client-server computing model in which virtual desktop environments are served to user equipment connected to a network. Systems of this type vary in their implementation, but generally involve separating certain aspects of a user desktop environment from the physical machine that serves as an end-point user access terminal. Common system architectures include remote desktop virtualization, application virtualization and local desktop virtualization. In those systems that employ local desktop virtualization, the software for implementing the desktop computing environment is executed on the local client device using hardware virtualization. Such an arrangement can offer certain advantages in scenarios where there is limited connectivity with a remote server.

In scenarios involving local desktop virtualization, a complete operating system image is stored on a remote server. Deploying such a desktop session can involve downloading at least portions of the operating system image to the local user endpoint equipment (client). In such scenarios, a remote provisioning server (such as a Citrix Desktop Player), uses a network connection to download a virtual disk to the local physical device comprising an endpoint. As is known, a virtual disk drive or a virtual disk is a software service that emulates an actual physical disk storage device. The local physical device in such scenarios can be a conventional desktop or laptop computer. The virtual disk can be provided for use with the local physical machine or a virtual machine which is instantiated at the local physical machine. Mounting the disk image makes it accessible to the local physical machine and can involve downloading the boot disk image for the operating system to the endpoint client machine.

### SUMMARY

The present disclosure concerns implementing systems and methods for provisioning a virtual disk at an endpoint client. The method involves calculating a plurality of local hash values for a plurality of local blocks comprising a local operating system boot disk in an endpoint client machine where a virtual disk is to be instantiated. The local hash values are used to create a local hash table (LHT), which further includes a plurality of memory location information values. The memory location information values specify where each local block corresponding to each of the plurality of local hash values is located.

The method further involves receiving from a provisioning server a group of image hash values for image blocks comprising an image boot disk. The image hash values are compared to at least the local hash values contained in the LHT to identify one or more matching hash values in the LHT which are identical to one or more of the image hash values. Thereafter, one or more of the local blocks corresponding to the matching hash values are copied at the endpoint client machine to one or more memory locations which are associated with the virtual disk.

The disclosure also concerns a system for provisioning a virtual disk at an endpoint client. The system is comprised of an endpoint client machine comprising an electronic processor circuit and at least one physical memory storage device on which is stored a local operating system boot disk. The endpoint client machine configured to calculate a plurality of local hash values for local blocks comprising the local operating system boot disk and to create a LHT as described above. The endpoint client machine receives from a provisioning server a plurality of image hash values for a plurality of image blocks comprising an image boot disk. The endpoint client is configured to use the received image hash values by comparing them to the local hash values contained in the LHT. This process facilitates identification of matching hash values in the LHT which are identical to one or more of the image hash values. The endpoint client is further configured to selectively copy one or more of the local blocks corresponding to the one or more matching hash values to one or more memory locations in the endpoint client machine which are associated with the virtual disk.

### BRIEF DESCRIPTION OF THE DRAWINGS

Embodiments will be described with reference to the following drawing figures, in which like numerals represent like items throughout the figures.

FIG. 1 is an illustration of an exemplary network and computing environment which is useful for understanding certain aspects of the disclosure.

FIG. 2 is an illustration that is useful for understanding certain aspects of a computing machine.

FIG. 3 is a block diagram which is useful for understanding a virtualization environment.

FIG. 4 is a flow diagram that is useful for understanding a process for provisioning a local endpoint client machine with a virtual boot disk.

FIG. 5 is a drawing that is useful for understanding the contents of a provisioning server hash table for an image boot disk.

FIG. 6 is a drawing that is useful for understanding the contents of a local hash table maintained at an endpoint client machine.

### DETAILED DESCRIPTION

It will be readily understood that the components of the disclosed methods and systems as generally described herein and illustrated in the appended figures could be arranged and designed in a wide variety of different configurations. Thus, the following more detailed description, as represented in the figures, is not intended to limit the scope of the present disclosure, but is merely representative of various possible scenarios. While the various aspects of the systems and methods are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

As is known, a magnetic data storage disk is divided into tracks and sectors. A track can be defined as that portion of a disk which will pass under a single stationary head during a disk rotation. A disk track is divided into a plurality of segments which are commonly referred to as sectors. The sector thus defines a physical portion of the disk track on which information is stored.

This disclosure will sometimes involve references to data blocks. A block represents a basic unit of physical storage on a physical disk drive. A block is comprised of a group of sectors that the operating system is capable of addressing. Blocks are identified to the operating system by a number, from 0 up to the total number of blocks on the disk. The group of sectors included in a block can be as few as one, but a block can also be comprised of a plurality of sectors. By defining a block as several sectors, an operating system can function with larger hard disk drives without increasing the number of block addresses.

The block commonly represents the smallest unit of data that an operating system can either write to a file or read from a file. As such, data transferred from a hard disk to a buffer memory is usually sent in blocks. The default NTFS Block Size is 4096 bytes or 4 kilobytes (kB). A page (or memory page as they are sometimes called) is also a unit of data storage. A memory page is a fixed-length contiguous block of virtual memory which is referenced by a single entry in a page table. The typical page size is also 4 kB of memory. For purposes of the present disclosure, the term block can also be understood to include a page.

A cluster is the allocation size used by the file system when allocating space on the disk. A cluster is comprised of one or more blocks. Accordingly, a cluster size will commonly be a multiple of the block size. When this is the case, file contents will always be written into equal size blocks, even if the cluster size is larger than the block size. The cluster size used by NTFS (the Windows file system) is a multiple of 4 kB and can be as high as 64 kB.

File systems which are layered on top of block devices will always write data in accordance with boundaries. So even if the same file is written to completely different locations on the disk, the sector contents will be identical on every disk containing the same file. So when space is allocated for a file, such allocation will be done in units of the cluster size and the file will be written to consecutive sectors in cluster sized chunks. Accordingly, no matter where the file is written on disk, there will be consecutive sectors holding the same data. In addition, file systems are implemented in partitions of the whole disk but those partitions typically start at offsets that are at least a multiple of 4 kB. The most typical cluster size is 4 kB so this would typically be the block size used when hashing portions of the disks for purposes disclosed herein.

Desktop virtualization can involve instantiating a virtual machine (VM) on a local client computer such as a desktop or laptop. The operation of such VM can be facilitated by provisioning such local client computer with a virtual disk. Fundamentally, a virtual disk is a sequential collection of fixed size data blocks. As such the virtual disk can be stored in any suitable manner, such as on a raw disk partition or in a virtual hard disk (VHD) file format (which is a file format that represents a virtual hard disk drive).

In some scenarios, a virtual disk can comprise digital data from which the local client computer can load and run an operating system. Such a virtual disk is sometimes referred to herein as a boot disk. When provisioning a VM, an image of such boot disk can be stored and made available to the endpoint client machine (ECM) from a provisioning server with access to suitable data storage resources. The data comprising the virtual disk is communicated to the ECM, where such data is then stored. But provisioning a virtual disk to a laptop or desktop computer as described herein necessarily involves sending large amounts of data over a potentially slow connection. Accordingly, one of the largest impediments to deploying a virtual desktop session running locally on an ECM is the time it takes to provision the data that comprises the image boot disk to the endpoint.

Various techniques can help reduce the amount of time required for the foregoing virtual disk deployment process. Data compression can help by reducing the amount of data to be communicated over the network. Beyond such conventional data compression techniques, differencing disks can also be used to speed up deployment. As is known, a differencing disk can comprise a virtual disk which is used to isolate changes to a different virtual disk. But these techniques do not address the basic problem of deploying the image boot disk initially, which can involve transmission of around 30 GB of uncompressed data (and 10 GB compressed data). Moving such large objects is slow and when deploying to many endpoints and can consume excessive portion of the available bandwidth for a long time.

But if an ECM is already running a version of the same operating system as the image boot disk being deployed (e.g., a version of the Windows® operating system), then much of the data comprising the image boot disk may in fact already be present on the client machine. In other words, the some of the data which is to be downloaded may already exist somewhere in the physical drive that is provided on the local endpoint hardware. Moreover, due to the various characteristics of block devices as described above, corresponding data stored in the local endpoint hardware will necessarily be stored within blocks which have identical content as compared to those which comprise the image boot disk.

In theory then, such identical data blocks do not need to be transferred if they can be definitively located and identified at the ECM. The methods and systems disclosed herein take advantage of this notion by using a hash-based approach to identify data blocks in the ECM that exactly correspond or match the data that is in the boot disk image to be downloaded from the provisioning server. More particularly, a hash function is used to facilitate detection of blocks associated with the image boot disk that are already present at a local physical machine. When the presence of such blocks is detected, the local copy of a particular block can be copied over from the physical disk of the ECM to the virtual disk being mounted in such machine. This process is advantageous because it avoids the need to transfer the corresponding data over the network. Moreover, the advantages of the techniques disclosed herein can be realized even if differencing disks are being used. In other words, this technique can further reduce the amount of data that has to be transferred from the differencing disk.

According to a solution disclosed herein, a provisioning server calculates and sends hashes of each disk block comprising the image boot disk, from the provisioning server to the ECM. The ECM (e.g., a local client desktop, laptop or tablet computer) will create and maintain a local hash table or relational database. The local hash table will include hash values corresponding to data blocks which are already present on the ECM. Initially, these data blocks will include only those blocks comprising the local boot disk or operating system disk stored in memory. The ECM can determine if a particular block identified by the provisioning server is already present on the ECM by comparing its hash to the hash values in the local hash table. If a hash value received from the provisioning server matches a hash in the local hash table, this will serve as an indication that the corresponding block is already present at the local machine.

If a particular block is already present at the local ECM, then a local copy operation is performed with respect to such data block. More particularly, the block identified by the matching hashes is copied from its existing memory location (e.g., a memory location associated with a physical disk at the ECM), to a memory location assigned to the virtual disk. This copy operation is performed instead of downloading the page over the network. Although reference is made here to memory blocks, it should be understood that the same process can be applied in scenarios where the data stored at the provisioning server and/or the ECM is organized into memory pages. All that is necessary is that the hashes be calculated on pages and/or blocks of equivalent size (e.g., 4 kilobytes).

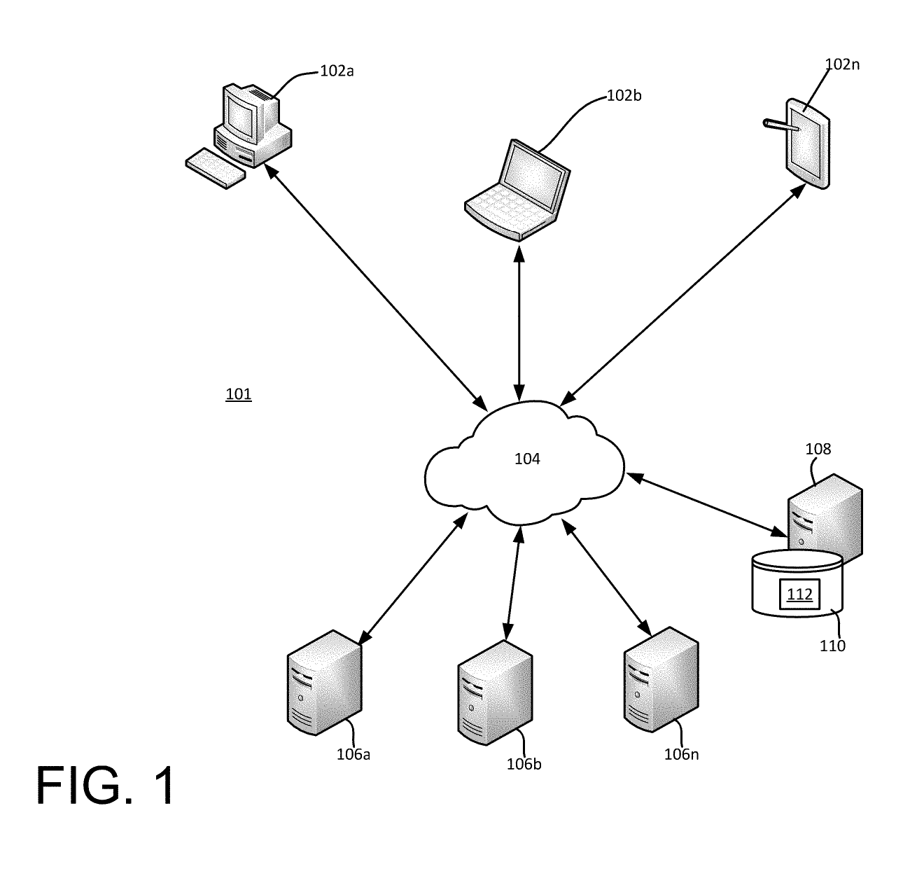

Referring now to FIG. 1, there is shown a schematic block diagram illustrating an example computing environment 101 in which certain aspects of the systems and methods described herein may be implemented. The computing environment 101 can include one or more ECMs 102a-102n (generally referred to herein as “client machine(s) 102a-n”). In some scenarios, the client machines can be in communication with servers 106a, 106b, 106n (hereinafter “servers 106a-n”) which help facilitate certain functions such as cloud computing operations. Installed between the client machine(s) 102a-n and servers 106a-n is a network 104. The computing environment 101 will include at least one provisioning server 108. The provisioning server 108 is operatively associated with at least one data storage device 110 on which is stored an image boot disk 112.

One or more of the ECMs 102a-n can support one or more VMs. For example, the VMs can be instantiated and execute in one or more of the client machines 102a-n to facilitate computing services offered to users of client machines 102a-n. In the context of this description, the term “virtual machine” or “VM” may denote a software emulation of a particular physical computer system. A VM may operate based on the computer architecture and functions of a real or hypothetical computer and their implementations may involve specialized hardware, software, or a combination of both. As explained below in further detail, the provisioning server 108 is advantageously configured to provision one or more ECMs 102a-n with a virtual disk based on the image boot disk 112. For example, the image boot disk 112 can be provisioned at an ECM 102a-n to support a VM which is instantiated at one or more of the local machines.

The server(s) 106a-n can be any server type and are not critical to the provisioning methods disclosed herein. For example, a server 106a-n can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server executing an active directory; or a server executing an application acceleration program that provides firewall functionality, application functionality, or load balancing functionality.

One or more client machine(s) 102a-n, server(s) 106a-n, and provisioning server 108 are configured to transmit data over the network 104. The network 104 can comprise one or more sub-networks. Moreover, the network can be installed between any combination of the client machine(s) 102a-n, server(s) 106a-n, and provisioning server 108 included within the computing environment 101. In some scenarios, the servers 106a-n may be omitted from the computing environment 101. The network 104 can be: a local-area network (LAN); a metropolitan area network (MAN); a wide area network (WAN); a primary network comprised of multiple sub-networks located between the client machines 102a-n, the servers 106a-n and the provisioning server 108; a primary public network with a private sub-network; a primary private network with a public sub-network 104; or a primary private network with a private sub-network.

Data storage device 110 can comprise any suitable memory storage system. In some scenarios, the data storage device 110 can be a hard disk drive (HDD) or other type of memory which is directly accessible to the provisioning server 108. In other scenarios, the data storage device can be accessed by the provisioning server remotely (e.g., by means of network 104). For example, the data storage device 110 can comprise a portion of a cloud-based data storage infrastructure. The cloud-based data storage infrastructure can comprise one or more physical data storage devices located at one or more data storage farms which are made accessible over the network 104. In some scenarios, the data storage device 110 can comprise an HDD that uses magnetic storage to store and retrieve digital information using one or more rigid rapidly rotating disks (platters) coated with magnetic material. In other scenarios, the data storage devices can include an optical data storage device in which digital data is stored on an optical medium, or a solid-state drive (SSD) which uses solid state computer storage media.

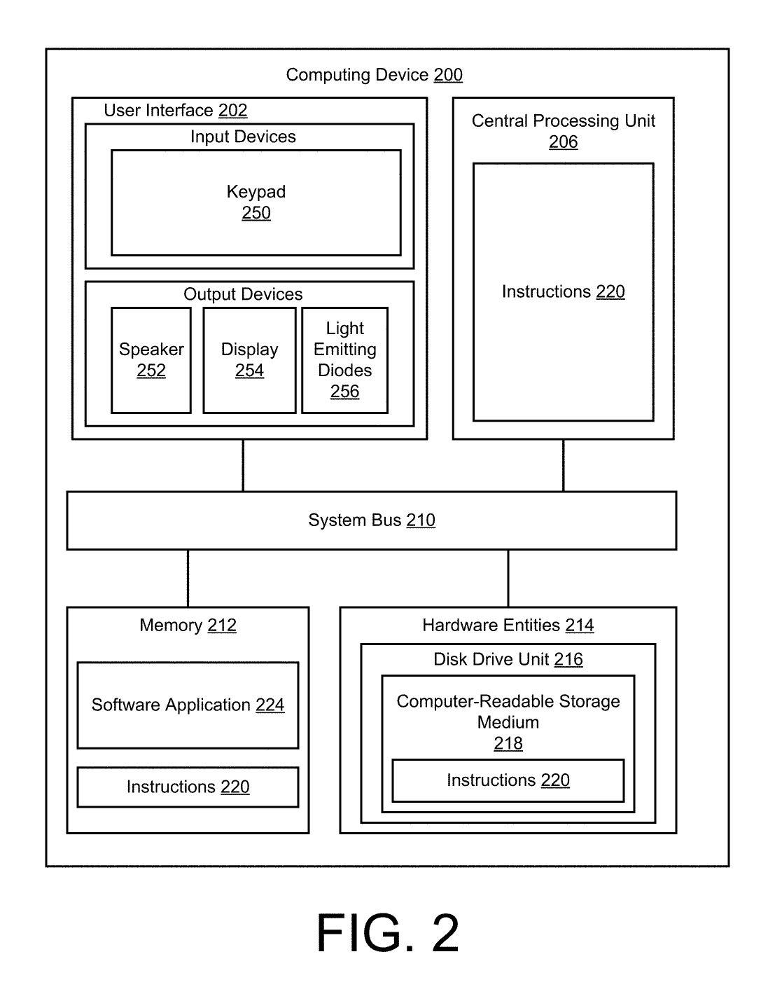

Referring now to FIG. 2, there is provided a detailed block diagram of an exemplary architecture for a computing device 200. The client machine(s) 102a-n, server(s) 106a-n, and servers 108 can be deployed as and/or execute on any embodiment of the computing device 200. As such, the following discussion of computing device 200 is sufficient for understanding client machine(s) 102a-n, server(s) 106a-n and data storage devices 108 of FIG. 1.

Computing device 200 may include more or less components than those shown in FIG. 2. However, the components shown are sufficient to disclose an illustrative embodiment implementing the present solution. The hardware architecture of FIG. 2 represents one embodiment of a representative computing device configured to facilitate storage and/or transmission of sensitive information in a cloud computing environment. As such, the computing device 200 of FIG. 2 implements at least a portion of a method for efficient provisioning of VMs to endpoint computers 102a-n.

Some or all the components of the computing device 200 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 2, the computing device 200 comprises a user interface 202, a Central Processing Unit (“CPU”) 206, a system bus 210, a memory 212 connected to and accessible by other portions of computing device 200 through system bus 210, and hardware entities 214 connected to system bus 210. The user interface can include input devices (e.g., a keypad 250) and output devices (e.g., speaker 252, a display 254, and/or light emitting diodes 256), which facilitate user-software interactions for controlling operations of the computing device 200.

At least some of the hardware entities 214 perform actions involving access to and use of memory 212, which can be a RAM, a disk driver and/or a Compact Disc Read Only Memory (“CD-ROM”). Hardware entities 214 can include a physical disk drive unit 216 comprising a computer-readable storage medium 218 on which is stored one or more sets of instructions 220 (e.g., software code) configured to implement one or more of the methodologies, procedures, or functions described herein. The instructions 220 can also reside, completely or at least partially, within the memory 212 and/or within the CPU 206 during execution thereof by the computing device 200. The memory 212 and the CPU 206 also can constitute machine-readable media. The term “machine-readable media”, as used here, refers to a single medium or multiple media (e.g., a centralized or distributed database, and/or associated caches and servers) that store the one or more sets of instructions 220. The term “machine-readable media”, as used here, also refers to any medium that is capable of storing, encoding or carrying a set of instructions 220 for execution by the computing device 200 and that cause the computing device 200 to perform any one or more of the methodologies, as described herein.

In some scenarios, the hardware entities 214 include an electronic circuit (e.g., a processor) programmed for facilitating secure, encrypted, shared cloud storage in a cloud computing environment. In this regard, it should be understood that the electronic circuit can access and run a software application 224 installed on the computing device 200. The functions of the software application 224 will become apparent as the discussion progresses.

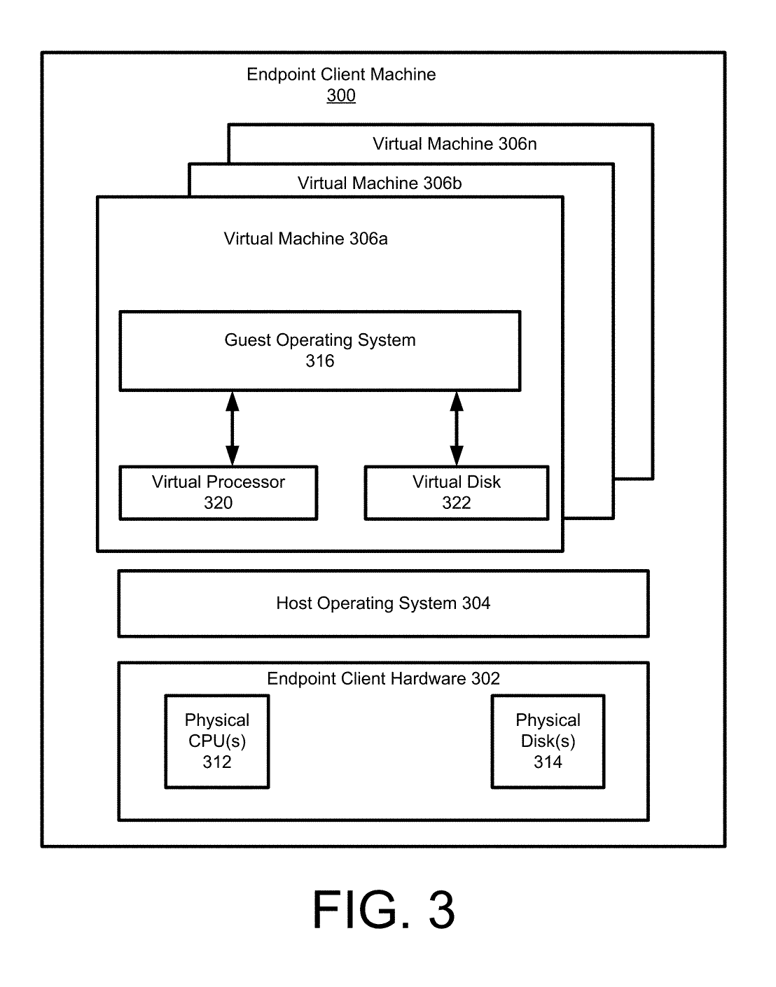

Shown in FIG. 3 is a virtualization environment which may be instantiated in an exemplary ECM 300. As such, ECM 300 is useful for understanding a virtualization environment that is instantiated in one or more ECMs 102a-n. ECM 300 includes endpoint client hardware 302, host operating system 304, and one or more VMs 306a, 306b, . . . 306n (hereinafter VMs 306a-n). The endpoint client hardware 302 includes a physical central processing unit (CPU) 312 and a data storage device such as a disk drive 314. Each of the VMs 306a-n is respectively comprised of a guest operating system 316 and a plurality of virtual resources allocated to the operating system. Virtual resources may include, without limitation, a virtual processor 320 and a virtual disk 322, as well as virtual resources such as virtual memory and virtual network interfaces.

A virtual disk 322 is a sequential collection of fixed size data blocks which comprise a single file or a set of files split into smaller parts. Each virtual disk 322 will comprise a plurality of blocks such that the data contained on the virtual disk may be referred to as blocked data. As is known, a block is comprised of a sequence of bits or bytes and usually contains some whole number of data records. Each block will have a predefined maximum length which defines a block size. Blocked data is usually read or written to a data buffer as one entire block at a time. VMs which are hosted on one or more of ECMs (e.g., ECMs 102a-n) can be facilitated by mounting one or more virtual disks (e.g. virtual disks 322) on such ECM. These virtual disks can be provided by the provisioning server (e.g. provisioning server 108) using an image disk stored in a data storage device (e.g., data storage device 110).

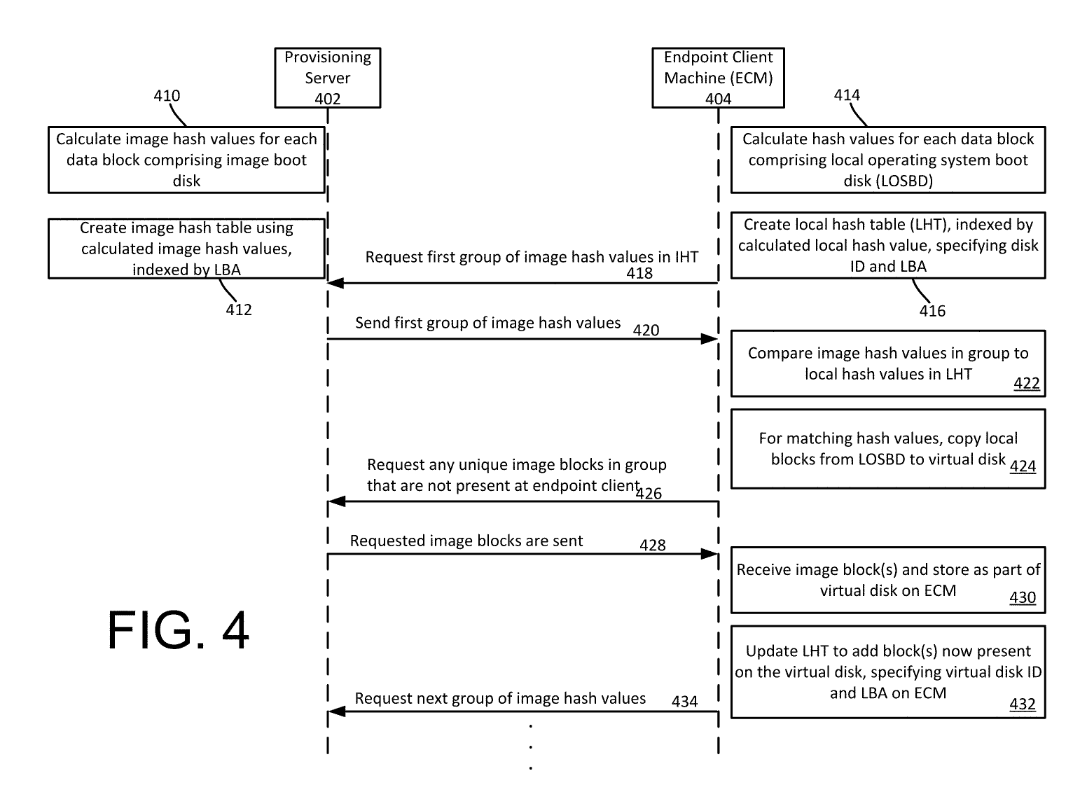

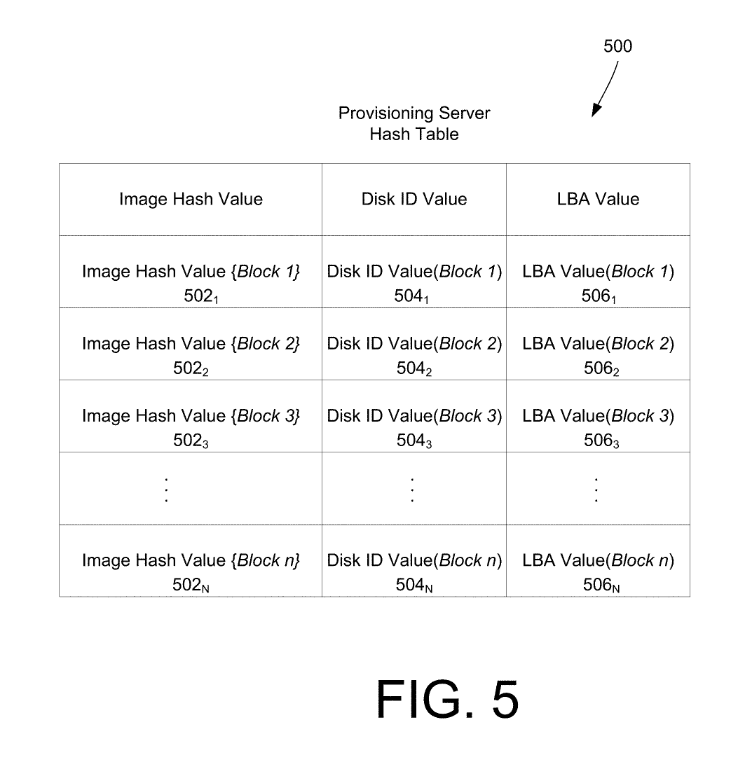

A process for provisioning a virtual disk (e.g., a virtual disk in a local ECM will now be described in greater detail with reference to FIG. 4. As shown therein, the process can begin with the provisioning server 402 calculating at 410 hash values of each block (image block) comprising the image boot disk which is to be downloaded to one or more ECMs. The hash values (which are sometimes referred to herein as image hash values) are used at 412 to create an image hash table (IHT). An example of a IHT 500 is shown in FIG. 5. As illustrated therein, the IHT can include image hash values 502₁, 502₂, . . . 502_{N} corresponding to each image block, a disk ID values 504₁, 504₂, . . . 504_{N} identifying an addressable disk where each particular image block is located, and a logical block address (LBA) values 506₁, 506₂, . . . 506_{N} indicating where the image block can be found on the identified disk. In some scenarios, the image hash values can be pre-calculated and simply stored in advance in the IHT so that it is not necessary to calculate 410 and build 412 the IHT at run time.

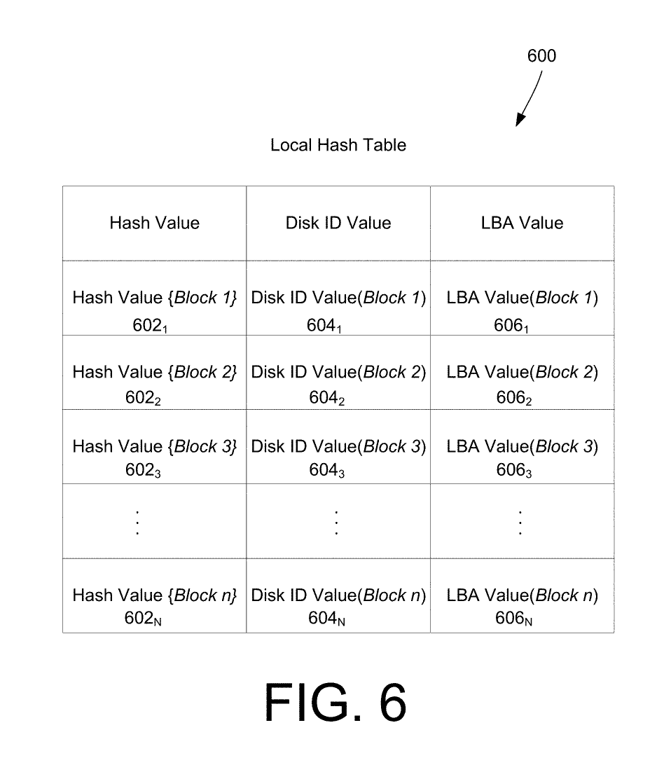

When ECM 404 is ready to mount the virtual disk it will calculate at 414 a hash value for each data block comprising its existing local operating system boot disk (LOSBD). These hash values are sometimes referred to herein as local hash values. This process of calculating local hash values will involve accessing a local physical disk or physical data store which is present at the ECM. The ECM will then create a local hash table (LHT) at 416 using the calculated local hash values. An example of an LHT 600 is shown in FIG. 6. As illustrated therein, the LHT can include local hash values 602₁, 602₂, . . . 602_{N} corresponding to each local data block, disk ID values 604₁, 604₂, . . . 604_{N} identifying an addressable disk where each particular local block is located, and a logical block address (LBA) values 606₁, 606₂, . . . 606N indicating where the block can be found on the identified disk. As discussed below in greater detail, the LHT 600 can be indexed on the basis of the calculated local hash values 602₁, 602₂, . . . 602_{N}.

At 418 an ECM 404 that is initializing a VM will request a first group of the image hash values which are contained in the IHT 500. The request can involve using suitable messaging, such as an HTTP “GET” request communicated over a network (e.g., network 104). The provisioning server will respond to this request at 420 by sending a first group of image hash values obtained from the IHT 500. When the image hash values are received, the ECM 404 will perform a comparison 422 of the image hash values contained in the received group to the local hash values in the LHT 600. The purpose of this comparison will be to determine if there are any image hash values in the received group that match the local hash values in the LHT.

The occurrence of matching hash values will indicate that a particular local block of data corresponding to the matching hash value is already present in a memory location associated with the ECM 404. The location of such block at the ECM can be determined by accessing the corresponding disk ID value and LBA value for that particular local hash value, as contained in the LHT 600. For any block that is determined by this method to be already present in the ECM, a copy 424 will be made of the corresponding data from its pre-existing memory location in the LOSBD, into a new memory location associated with the virtual disk that is being installed or mounted at the ECM.

For image blocks that are determined to be absent locally, the ECM will send a message 426 to the provisioning server 402, requesting download of any unique blocks. For example, in some scenarios this can be accomplished using an HTTP GET message to request resources available to the provisioning server 402. At 428 the provisioning server will send the requested image blocks. When this data is received at the ECM, it will be stored 430 at the ECM as part of the virtual disk. The ECM will also update 432 or append the LHT 600 to indicate that the received block or blocks are now present on the virtual disk at the ECM. For each such hash entry, the LHT 600 will also include entries specifying a disk ID value 604₁, 604₂, . . . 604_{N} and an LBA values 606₁, 606₂, . . . 606N. Thereafter, at 434 the ECM requests from the provisioning server 402 the next group of image hash values from the IHT. The process continues in this way until all of the necessary data associated with the target image boot disk has been communicated from the provision server, or copied from an LOSBD at the endpoint computer 404.

As is known, a hash value is calculated using a hash function. The hash function can be any function which is capable of producing from a block of data of arbitrary size a hash value of fixed bit length. The hash value will comprise a bit string of shorter length than the original block of data. The same hash function will return the same hash value every time it operates on the original data file. Accordingly, a hash value can serve as a kind of a digital signature with respect to the content of the data file. If any changes are made to the file, then the hash function will return a different hash value. Hash functions and hash values are well-known in the art and therefore will not be described here in detail.

For purposes of the present disclosure, it should be understood that any of a wide variety of well-known hash functions can be used without limitation. Still, it should be appreciated that optimal results can be achieved by using a which is selected to reduce the chances of incorrect data being copied from the existing memory of the local ECM, to the virtual disk which is being installed. Desirable attributes to facilitate the techniques and method disclosed herein are that that the hash function: (1) is deterministic so the same message always results in the same hash, (2) offers quick computation of the hash value for any given data block, and (3) generates hash values in a way such that it is infeasible to find two different blocks with the same hash value. Notably, many cryptographic hash functions offer these attributes, and therefore cryptographic hash functions can be suitable for carrying out the hashing operations disclosed herein. Non-limiting examples of suitable hash functions which can be used for these purposes can include SHA-1, SHA-256, and BLAKE-2.

When hash functions having the above-stated attributes are used, the chance of a hash collision very remote. Accordingly, there is no need to compare the actual stored data at the provisioning server and the ECM when a hash match is detected. To appreciate why this is so, it is important to recognize that where a random hash algorithm generates an N bit hash, the probability of a collision across P blocks is approximately P2/2N+1. Consider an instance where a 256 bit hash is used, and a 30 GB disk is broken into 4 K chunks. If the local disk is 30 GB then there is a total of 60 GB of data or approximately 15,000,000 blocks being compared. In such a scenario, the chance of a collision (using P2/2N+1) is approximately 1×10-63. In addition, when using a 256-bit hash per 4 kB page, there is a 8 k fold reduction in the amount of data that is transferred for each block that is present locally. If the operating system installed at the ECM and the image boot disk stored at the provisioning server are the same version (e.g., the same version of the well-known Windows® operating system), there should be a very high hit rate of matching blocks. Consequently, much less data needs to be transferred over the network.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A method for provisioning a virtual disk at an endpoint client, comprising:
calculating a plurality of local hash values for a plurality of local blocks comprising a local operating system boot disk in an endpoint client machine where a virtual disk is to be instantiated;
creating a local hash table (LHT) containing at least the plurality of local hash values and, including a plurality of memory location information values specifying where each local block corresponding to each of the plurality of local hash values is located;
receiving from a provisioning server a plurality of image hash values for a plurality of image blocks comprising an image boot disk;
comparing the plurality of image hash values to at least the plurality of local hash values contained in the LHT to identify one or more matching hash values in the LHT which are identical to one or more of the plurality of image hash values;
selectively copying one or more of the local blocks corresponding to the one or more matching hash values to one or more memory locations in the endpoint client machine which are associated with the virtual disk.

2. The method according to claim 1, wherein each of the plurality of memory location information values includes a disk identification value and a logical block address value.

3. The method according to claim 1, wherein the LHT further contains at least one stored image hash value which has been previously stored to a memory location associated with the virtual disk, and wherein the comparing step further comprises comparing the plurality of image hash values received from the provisioning server to the at least one stored image hash value contained in the LHT.

4. The method according to claim 1, further comprising in response to the comparing, requesting from the provisioning server at least one of the image block which has an image hash value that is absent from the LHT.

5. The method according to claim 4, further comprising receiving the at least one image block which has been requested from the provisioning server, and storing the at least one image block in at least a second memory location in the endpoint client machine which is associated with the virtual disk.

6. The method according to claim 5, further comprising appending the LHT to include the image hash values corresponding to the at least one image block which has been stored.

7. The method according to claim 6, further comprising appending the LHT to include one or more of the memory location information values to specify where the at least one image blocks is stored in the endpoint client machine.

8. The method according to claim 7, wherein the memory location information values include for each local hash value and image hash value, a disk identification value and a logical block address value.

9. The method according to claim 1, wherein a hash function that is used to compute the local hash value is a cryptographic hash function which maps data comprising each unique local block to a different hash value, with vanishingly small chance of collision.

10. The method according to claim 1, wherein the provisioning of the virtual disk is performed to facilitate the operation of a virtual machine at the endpoint client machine.

11. A system for provisioning a virtual disk at an endpoint client, comprising:
an endpoint client machine comprising an electronic processor circuit and at least one physical memory storage device on which is stored a local operating system boot disk;
said endpoint client machine configured to:
calculate a plurality of local hash values for a plurality of local blocks comprising the local operating system boot disk;
create a local hash table (LHT) containing at least the plurality of local hash values and, including a plurality of memory location information values specifying where each local block corresponding to each of the plurality of local hash values is located;
receive from a provisioning server a plurality of image hash values for a plurality of image blocks comprising an image boot disk;
compare the plurality of image hash values to at least the plurality of local hash values contained in the LHT to identify one or more matching hash values in the LHT which are identical to one or more of the plurality of image hash values;
selectively copy one or more of the local blocks corresponding to the one or more matching hash values to one or more memory locations in the endpoint client machine which are associated with the virtual disk.

12. The system according to claim 11, wherein each of the plurality of memory location information values includes a disk identification value and a logical block address value.

13. The system according to claim 11, wherein the LHT further contains at least one stored image hash value which has been previously stored to a memory location associated with the virtual disk, and wherein the endpoint client machine is further configured to compare the plurality of image hash values received from the provisioning server to the at least one stored image hash value contained in the LHT.

14. The system according to claim 11, wherein the endpoint client machine is further configured, to request from the provisioning server, as a result of the comparing, at least one of the image blocks which has an image hash value that is absent from the LHT.

15. The system according to claim 14, wherein the endpoint client machine is further configured to receive the at least one image block which has been requested from the provisioning server, and storing the at least one image block in at least a second memory location in the endpoint client machine which is associated with the virtual disk.

16. The system according to claim 15, wherein the endpoint client machine is further configured to append the LHT to include the image hash values corresponding to the at least one image block which has been stored.

17. The system according to claim 16, wherein the endpoint client machine is further configured to appending the LHT to include one or more of the memory location information values to specify where the at least one image blocks is stored in the endpoint client machine.

18. The system according to claim 17, wherein the memory location information values include for each local hash value and image hash value, a disk identification value and a logical block address value.

19. The system according to claim 11, wherein a hash function that is used to compute the local hash value is a cryptographic hash function which maps data comprising each unique local block to a different hash value, with vanishingly small chance of collision.

20. The system according to claim 11, wherein the endpoint client machine is configured to provision the virtual disk to facilitate the operation of a virtual machine at the endpoint client machine.
